(19) United States
(12) Patent Application Publication
(10) Pub. No.: US 2023/0220229 A1
(43) Pub. Date: Jul. 13, 2023

(54) CONDUCTIVE AQUEOUS INK COMPOSITION FOR SCREEN PRINTING, CONDUCTIVE PATTERN MANUFACTURED USING SAME, AND CONDUCTIVE DEVICE COMPRISING SAME

(71) Applicant: DAEDONG CO., LTD., Busan (KR)

(72) Inventors: Seung Taeg LEE, Busan (KR); Cheol Joo LEE, Busan (KR); Hee Jung NOH, Busan (KR)

(73) Assignee: DAEDONG CO., LTD., Busan (KR)

(21) Appl. No.: 17/927,693

(22) PCT Filed: Jul. 7, 2021
(86) PCT No.: PCT/KR2021/008673

§ 371 Date: Nov. 24, 2022

(30) Foreign Application Priority Data
Jul. 8, 2020 (KR) 10-2020-0084136

(51) Int. Cl. C09D 11/52; C09D 11/033

(52) U.S. Cl. CPC C09D 11/52; C09D 11/033

(57) ABSTRACT

The present disclosure relates to a conductive aqueous ink composition for screen printing, a conductive pattern manufactured using the same, and a conductive device comprising the same, wherein the ink composition is applicable to plastic bases and the like through low-temperature firing and can serve as an aqueous ink to improve a working environment. More specifically, a conductive aqueous ink composition for screen printing, a conductive pattern manufactured using the same, and a conductive device comprising the same are disclosed wherein the ink composition comprises: metal nanoparticles (A) protected by a dispersion stabilizer and having a particle size in the range of 5 to 50 nm; and a water-soluble solvent (B), the dispersion stabilizer containing: a protective polymer composed of branched polyalkylene imine segments and polyoxyalkylene segments; and an amine acid salt composed of an amine and an inorganic acid.

### TECHNICAL FIELD

The present disclosure relates to a conductive aqueous ink composition for screen printing, which can be applied to plastic substrates and the like by low-temperature firing and can make a good working environment as an aqueous ink, a conductive pattern manufactured using the same, and a conductive device including the same.

### BACKGROUND ART

The manufacture of printed wiring board semiconductor devices and ultrafine wiring is almost always manufactured through a photolithography process. In this case, because a photolithography process goes through a complex multi-step manufacturing process, recently, a technology for manufacturing a coating-type electronic device in which metal nanoparticles, which are being developed, are dispersed in a solvent and used as an ink mixing compounds, patterned by various printing methods, and manufactured into various devices is attracting attention. This technology is called printed electronics. Specifically, printed electronics are possible to mass-produce electronic circuit pattern semiconductor elements and ultra-fine wiring in a roll-to-roll manner, which is expected to simplify the on-demand process and economic efficiency by saving energy, so printed electronics are expected to develop efficient manufacturing methods such as display device light emission and heating device electronic, electric device. As the conductive material ink used in printed electronics, conductive ink containing metal nanoparticles such as gold, silver, platinum, copper, etc., can be used, and silver nanoparticles and their inks have been developed in advance for economic feasibility and ease of handling.

On the other hand, when the metal size of the silver nanoparticles becomes smaller than the nano unit size, the specific surface area of the silver nanoparticle becomes much larger than that of bulk silver, and surface energy increases, so there is a strong tendency to degrade surface energy by mutual fusion. As a result, the particles are easily fused at a temperature much lower than the melting point of bulk silver due to the quantum size effect. Accordingly, there is an advantage of using silver nanoparticles as a conductive material. However, since the easy-to-fuse property of metal nanoparticles makes it difficult to stabilize the metal nanoparticles and thus degrades dispersion stability, it is necessary to stabilize the metal nanoparticles and protect them with a dispersion stabilizer to prevent fusion. Accordingly, a method of forming conductive wiring by using silver inks for screen printing composed of nanometer-sized nano silver particles on general-purpose plastics such as polyethylene terephthalate or polyethylene naphthalate that is inexpensive and has low heat resistance but is easy to thin-film and flexible to mold by printing fine patterns using silver inks and firing them at low temperatures below 150° C., is known.

Meanwhile, as awareness of environmental issues and product safety has recently increased, regulations on chemical substances have become stricter, and there is a strong tendency to regulate the total amount of emissions in the industry and to suppress the emission of chemical substances. In relation to this, compared to oil-based ink, which is a petroleum-based solvent, aqueous ink is non-flammable and safe, resource-rich, and economical. The use of aqueous ink according to the regulation of these advantages and harmful chemicals is essentially required. In addition, if the liquid medium of the screen ink is water-based rather than oil-based, mainly organic solvent, the working environment can be well managed when printing, and the risk of fire or explosion can be reduced, so the use of water ink is further required.

In addition, the screen printing method, as is well known, is to place screen printing ink on the screen, apply force with a squeegee, etc., and press screen printing ink on the printing substrate through the screen's net. Recently, such screen printing requires slimming electronic devices, applying thin films due to the high internal density of the electronic device, applying thick films to improve circuit insulation, applying high viscosity materials to ultra-fine lines, and improving print position precision due to the miniaturization of electronic devices. It is used in various fields such as screen printing, multi-layer ceramic capacitors, multi-layer inductors, chip resistance, solder cream printing, flexible devices, and MEMS.

For this purpose, in order to form a sophisticated print pattern by the screen printing method, it is important to adjust the viscosity of the screen ink and the composition of the ink. In particular, it is important to have good conductivity in order to be applied to electronic devices. In relation to this, Patent Literature 1 discloses a conductive screen ink in which the viscosity of the ink is adjusted, and Patent Literature 2 discloses a conductive ink using silver particles with an average particle diameter of 1 to 100 nm, but the volume resistance in 150° C. firing is as high as 2.0 to 15×10⁻⁵ Ω·cm after printing, and it is limited to oil-based screen ink using synthetic resins and organic solvents. In other words, aqueous ink for screen printing is possible to manufacture circuit wiring with good volume resistance by low-temperature firing on a plastic base substrate having weak heat resistance, and aqueous ink for screen printing with good conductivity is required.

Accordingly, the present inventors have studied the above technical requirements, and as a result, the present disclosure has been completed by finding that metal nanoparticles protected by a dispersion stabilizer composed of a mixture of a protective polymer composed of a branched polyalkylene imine segment and a polyoxyalkylene segment and a low molecular weight aminates are effective as aqueous screen printing inks that can exhibit good conductivity in low-temperature firing and are good for working environment management.

### DISCLOSURE

### Technical Problem

Therefore, the technical solution of the present disclosure is to provide a conductive aqueous ink composition for screen printing, including metal nanoparticles protected by dispersion stabilizers and a water-soluble solvent so that it can be applied to plastic substrates, etc., by low-temperature firing and can exhibit good conductivity while improving the working environment as an aqueous ink.

Another technical solution of the present disclosure is to provide a conductive pattern prepared by using the conductive aqueous ink composition for screen printing.

The other technical solution of the present disclosure is to provide a conductive device including the conductive pattern.

### Technical Solution

In order to solve the above technical problem, the present disclosure provides a conductive aqueous ink composition for screen printing, the composition including:

metal nanoparticles (A) protected by a dispersion stabilizer and having a particle size in the range of 5 to 50 nm; and a water-soluble solvent (B), in which

the above dispersion stabilizer includes: protective polymers composed of branched polyalkylene imine segments and polyoxyalkylene segments; and amine salts composed of amine and inorganic acids.

In the present disclosure, the ink further includes metal particles (C) having a particle size in the range of 100 to 700 nm.

In addition, in the present disclosure, the composition has the solid content of the metal nanoparticles or the solid content of the metal nanoparticles and the metal particles of 60% to 90% by weight.

In addition, in the present disclosure, the aqueous solvent is at least one selected from alkylene glycol-based solvents or glycerin.

In addition, in the present disclosure, the metal nanoparticles or metal particles are silver nanoparticles or silver particles.

In addition, the present disclosure in order to solve the other technical problems described above provides a conductive pattern that

is prepared by printing and firing using the conductive aqueous ink composition on a substrate.

In addition, the present disclosure in order to solve the other technical problems described above provides a conductive device including the conductive pattern.

### Advantageous Effects

The conductive aqueous ink composition for screen printing obtained in the present disclosure exhibits good conductivity as well as good low-temperature firing properties. Such low-temperature firing properties and good conductivity are due to the fact that the dispersion stabilizer of metal nanoparticles composed of a mixture of a polymer including a branched polyalkylene imine segment and a polyoxyalkylene segment and a low molecular weight aminates can be easily removed from the surface of the metal nanoparticles at low temperatures, and then the activated metal nanoparticles are firmly fused.

In addition, unlike conventional oil ink, conductive aqueous ink for screen printing obtained in the present disclosure does not dissolve or swell general-purpose plastic substrates, has no odor or toxicity, so there is no deterioration of the working environment, and no risk of fire or explosion. In addition, the electrically conductive aqueous ink composition is printed by screen printing method and is fired at a low temperature compared to the related art, thereby showing a technical effect capable of forming circuit wirings and the like exhibiting good conductivity.

### DESCRIPTION OF DRAWINGS

FIG. 1 shows a TEM image of silver nanoparticles prepared according to an embodiment of the present disclosure;

FIG. 2 shows lines of various line widths screen-printed on a PET substrate according to an embodiment of the present disclosure; and

FIG. 3 shows an SEM photograph of the surface and cross section of the printed film after firing at 120° C. for 30 minutes after screen printing according to an embodiment of the present disclosure.

### BEST MODE

Hereinafter the present disclosure will be described in more detail.

The present disclosure relates to a conductive aqueous ink composition for screen printing, and the composition includes metal nanoparticles (A) which are protected by a dispersion stabilizer and have a particle size in the range of 5 to 50 nm; and a water-soluble solvent (B). Preferably, the ink further includes metal particles (X) having a particle size in the range of 100 to 700 nm. The dispersion stabilizer included in the composition of the present disclosure includes: a protective polymer including a branched polyalkylene imine segment (a) and a polyoxyalkylene segment (b); and an aminates (c) composed of an amine and an inorganic acid, thereby exhibiting high dispersion stability and protecting metal nanoparticles, thereby exhibiting good conductivity even in low-temperature firing. That is, in the present disclosure, the dispersion stabilizer of metal nanoparticles composed of a mixture of a polymer including a branched polyalkylene imine segment and a polyoxyalkylene segment, and an aminates is easily separated from the surface of the metal nanoparticles at a low temperature, and then activated metal nanoparticles are firmly fused to exhibit good low-temperature firing properties and good conductivity.

In the present disclosure, the polyalkylene imine segment (a) in the protective polymer composed of the dispersion stabilizer is a segment capable of immobilizing a metal into nanoparticles because a nitrogen atom part of the alkylene imine may form a coordinate covalent bond with a metal or metal ion. Accordingly, when the metal nanoparticles protected with the protective polymer of the present disclosure are prepared or stored in a hydrophilic solvent, the polyalkylene imine segment (a) and the polyoxyalkylene segment (b) have hydrophilicity, and the polyalkylene imine segment (a) is immobilized on the surface of the metal nanoparticles by forming a coordinate covalent bond with the metal, whereas the polyoxyalkylene segment (b) moves freely in the solvent and becomes a repulsive force between the metal nanoparticles, resulting in excellent dispersion stability and storage stability in the resulting metal colloidal solution.

The number of alkyleneimine units in the polyalkylene imine segment (a) is not particularly limited, but when the number of units is too small, the protective ability of the metal nanoparticles as a protective polymer is likely to be insufficient, whereas when the number of units is too large, the particle diameter of the metal nanoparticles composed of metal nanoparticles and the protective polymer is easy to increase, which hinders dispersion stability. Accordingly, in consideration of the immobilization ability of the metal nanoparticles or the ability to prevent the macro-enlargement of the nanoparticles, the number of alkyleneimine units in the polyalkylene imine segment (a) is usually in the range of 10 to 5,000, more preferably 100 in the range of 100 to 2,000.

In addition, the polyalkylene imine segment (a) includes branched polyalkylene imine among linear polyalkylene imine containing only secondary amines and branched polyalkylene imine containing primary, secondary, and tertiary amines, and in this disclosure, it can be used without particular limitation as long as it is commercially available or synthesized. Preferably, since metal nanoparticles may be dispersed in solvent compositions of various polarities by controlling the degree of polarity by the kind or number of introduced functional groups, and thus branched polyalkylene imine may preferably be used. More preferably, branched polyethylene imine or branched polypropylene imine is preferable in the consideration of being easily obtained industrially, and in particular, branched polyethylene imine is even more preferable.

The weight-average molecular weight of the protective polymer composed of the polyalkylene imine segment (a) and the polyoxyalkylene segment (b) is not particularly limited, but when a hydrophilic medium is used, if the weight-average molecular weight of the protective polymer is too small, dispersion stability deteriorates due to reduced protective capacity of metal nanoparticles as a protective polymer, on the other hand, if the weight-average molecular weight of the protective polymer is too large, since the nanoparticles are agglomerated, the particle diameter or stability of the metal nanoparticles in the colloidal solution is hindered. Therefore, the weight-average molecular weight of the protective polymer, which is composed of the polyalkylene imine segment (a) and the polyoxyalkylene segment (b), is usually in the range of 500 to 150,000, and more preferably in the range of 1,000 to 100,000.

The polyoxyalkylene segment (b) is a segment that exhibits high affinity with a solvent and maintains the storage stability of the colloidal solution when a hydrophilic medium such as water is used as the metal colloidal solution. The polyoxyalkylene segment (b) can be used without particular limitation as long as it is generally commercially available or synthesized, in particular, when a hydrophilic solvent is used, a colloidal solution excellent in stability may be obtained, and thus the polyoxyalkylene segment is preferable to be made of a nonionic polymer.

As the polyoxyalkylene segment (b), for example, a polyoxyethylene segment or a polyoxypropylene segment is preferred, and a polyoxyethylene segment is more preferred from the viewpoint of industrial availability.

In addition, low molecular weight amines prepared by the aminates exchange between the polyalkylene imine and the aminates can be immobilized on the surface of the metal nanoparticles by forming a coordinate covalent bond with the metal, thereby contributing to the improvement of dispersion stability in aqueous solution. Therefore, the amine in the present disclosure is a low molecular weight amine that can be easily removed at low temperatures, for example, methylamine, dimethylamine, methylethylamine, ethylamine, diethylamine, propylamine, isopropylamine, butylamine, isobutylamine, pentylamines, and the like may be used. In addition, the low molecular weight aminates (c) containing the low molecular weight amine may include, for example, hydrochloric acid, nitric acid, sulfuric acid, etc., as an inorganic acid.

As described above, the low molecular weight aminates (c) composed of the amine and the inorganic acid contributes to improved dispersion stability and good conductivity. At this time, the amine, which is a component of the aminates (c), may have a boiling point in the range of 180° C. or less, and more preferably in the range of 50° C. to 130° C. This is because when the conductive material prepared by adjusting a dispersion of metal nanoparticles protected by a dispersion stabilizer, that is, an aqueous metal colloidal solution or an aqueous solution thereof to a conductive ink for screen printing, is printed or applied on the substrate, the amine generated by the aminates exchange between polyalkylene imine and aminates is easily removed at low temperature, thereby contributing to the improvement of conductive performance. Therefore, the ink composition for screen printing of the present disclosure, which is a colloidal metal solution in which the metal nanoparticles protected by the dispersion stabilizer are dispersed, exhibits good conductivity even at low-temperature firing.

In addition, as described above, the dispersion stabilizer of the metal nanoparticles includes a polyoxyalkylene segment (b), and a low molecular weight aminates (c) in addition to the polyalkylene imine segment (a) of the protective polymer allowing the metal nanoparticles to exist in a stable state. As described above, the polyoxyalkylene segment (b) exhibits good affinity with the solvent in a hydrophilic solvent. At this time, when the number of alkylene imine units in the polyalkylene imine segment (a) is in the range of 100 to 2,000, the use ratio of the protective polymer composed of the branched polyalkylene imine segment (a) and the polyoxyalkylene segment (b) and the low molecular weight aminates (c) in the mixture is determined by adjusting the amine equivalent of the low molecular weight aminates (c) to the amine equivalent of the polyalkylene imine segment (a), thereby improving good conductivity and dispersion stability at low-temperature firing. At this time, preferably, the amine equivalent of the low molecular aminates (c) with respect to one equivalent of the amine of the polyalkylene imine segment (a) may be in the range of 0.1 to 1.0 equivalents, and more preferably in the range of 0.1 to 0.7 equivalents.

In addition, the metal nanoparticle protective polymer of the present disclosure, which is composed of the polyalkylene imine segment (a) and the polyoxyalkylene segment (b), cannot sufficiently protect the metal nanoparticles when the metal nanoparticle protective polymer is used in an excessively small amount, but when the metal nanoparticle protective polymer is used in an excessively large amount, unnecessary dispersion stabilizers are overused. In the separation and purification process of metal nanoparticles, the excess dispersion stabilizer interferes with the separation, thereby deteriorating the purification separability. Therefore, in the metal nanoparticle protective polymer of the present disclosure, the amount of the metal nanoparticle dispersion stabilizer is not particularly limited but is desirably 2% to 15% by weight, more desirably 3% to 10% by weight, of the metal nanoparticles obtained from the viewpoint of dispersion stability, preservation stability, and good conductive performance of the metal colloidal aqueous solution obtained by synthesis.

In the method for preparing metal nanoparticles (A), which is an important component of the conductive aqueous ink for screen printing of the present disclosure, for example, the metal nanoparticles (A) may be prepared by adding and reducing a small amount of metal ions into a solvent of a polymer, adding the remaining amount of metal ions again after a predetermined time and reducing to obtain metal nanoparticles, adding an appropriate poor solvent, precipitating, and separating the metal nanoparticles, thereafter, adding a low molecular weight aminates C to a concentrated solution of the separated metal nanoparticles. As a raw material for a metal ion, a metal salt or a metal ion solution can be mentioned. As a raw material for the metal ion, any water-soluble metal compound may be used, and salts of a metal cation and an acid group anion or a metal containing an acid group anion can be used. In addition, metal ions having metal types such as transition metals can be used, but among these metal ions, metal ions of silver, gold, and platinum are good because they are spontaneously reduced at room temperature or heated and converted into nonionic metal nanoparticles. Moreover, when using the obtained colloidal metal solution as an electrically-conductive material, it is preferable to use silver ions from the viewpoint of conductive expression ability or oxidation prevention of the coating film obtained by printing or painting.

The metal nanoparticles (A) prepared by the above method generate quaternary amine units of the polyalkylene imine by aminates exchange between the added low molecular weight aminates (c) and the polyalkylene imine segment of the protective polymer. The quaternary amine units of the polyalkylene imine prepared by amine exchange between branched polyalkylene imine and amine salt are easily separated (decoupled) at low temperature on the surface of the metal nanoparticles forming coordination covalent bond because of its weak binding force. Accordingly, low-temperature firing is possible, the separation is easy and complete, and the protective polymer does not impair the conductivity during the fusion process between the separated metal nanoparticles and thus has good conductive performance.

In addition, in the present disclosure, the ink composition may further include metal particles (X) having a particle size in the range of 100 to 700 nm. In this case, the metal particles (X) may be completely filled with the metal nanoparticles (A) in a space between the particles, thereby forming a completely filled film. When the metal nanoparticles are heated and fired in such a state, the protective polymer is easily separated (decoupled) from the surface of the metal nanoparticles (A) even at a low temperature, and the metal nanoparticles (A) are fused. At this time, the metal nanoparticles (A) in the fully filled film fill the space between the metal particles (X) used together, maintain a fully filled state, and become a fully fired body integrated into the form of metal nanoparticles (A) connecting them, thereby exhibiting better conductive performance.

In the present disclosure, the metal particles (X) having an average particle diameter in a range of 100 to 700 nm are used together with the metal nanoparticles (A) having an average particle diameter in a range of 5 to 50 nm. The metal particles (X) have a significantly larger particle diameter than the metal nanoparticles (A), and are in a stable state that do not need to be protected by a dispersion stabilizer or the like, such as metal nanoparticles. As the metal particles (X), any conventional dry powder known may be used. Metal particles (X) may include, for example, metal particles such as gold, silver, copper, platinum, etc., but considering that the screen printing mesh may not be clogging, a fine pattern may be formed, a resistance value after firing is low, and a circuit wiring may be formed with good surface smoothness, metal particles having an average particle diameter of 100 to 700 nm and thin film flake silver particles may be preferred.

In the present disclosure, the metal nanoparticles (A) are used in combination with the metal particles (X) to easily obtain a film having better volume resistance in thermal firing than when only the metal nanoparticles (A) are used. At this time, the ratio of the metal nanoparticles (A) to the metal particles (X) is not particularly limited, but metal nanoparticles (A)/metal particles (X)=10/90 to 80/20 are preferable as the mass ratio. Moreover, considering that good volume resistance can be obtained even by using the metal nanoparticles (A) in a small ratio, the metal nanoparticles (A)/metal particles (X)=15/85 to 40/60 as a mass ratio is preferable.

In preparing the conductive aqueous ink composition applicable to the screen printing method, the total of the metal nanoparticles (A) and the metal particles (X) protected by the dispersion stabilizer on the basis of the mass of the non-volatile material is contained to be 55% or more, and more preferably 60% to 90%. In order to improve the screen printing properties, a method of increasing the content of non-volatile material in the ink composition is effective, but for this purpose, a binder resin is used additionally. It is preferable to adjust the binder resin used as the third component to the minimum required amount since the added binder resin remains an unnecessary resistance component in the film during firing.

The conductive ink for screen printing of the present disclosure is not an oil-based ink mainly composed of an organic solvent as in a conventional ink liquid medium, but an aqueous ink mainly composed of water. By using aqueous ink instead of oil-based ink, a good working environment can be maintained during the printing process, and the risk of fire or explosion can be reduced.

In the present disclosure, the water-soluble solvent (B) has the ability to prepare liquid aqueous ink to screen print and apply a metal nanoparticle (A) aqueous solution protected by a dispersion stabilizer composed of a mixture of a polymer including polyalkylene imine segment having a side chain and a polyoxyalkylene segment, and a low molecular weight aminates. In the present disclosure, the substrate material may be an inorganic or organic material having high heat resistance, such as a glass metal plate, ceramic polyimide, or the like, to thermoplastic having low heat resistance and flexibility. Therefore, a water-soluble solvent that can perform firing at low temperatures without dissolving or swelling the substrate material and has a low risk of fire or explosion without worsening the working environment, such as odor or toxicity, is selected and used.

In the present disclosure, as such, a water-soluble solvent (B), an alkylene glycol-based or glycerin, is used. As such, an alkylene glycol-based, for example, alkylene glycol, which is a liquid at room temperature such as diethylene glycol, triethylene glycol, tetraethylene glycol, dipropylene glycol, and tripropylene glycol, is good, and among them, alkylene glycol, which starts volatilization around 150° C., is better, and glycerin is also good. Water-soluble solvents have good mixing with the aqueous metal nanoparticle solution protected by the dispersion stabilizer, which is composed of a mixture of the polymer including polyalkylene imine segment and polyoxyalkylene segments, and low molecular weight aminates, does not cause phase separation, does not dissolve or swell various thermoplastics, allows firing at low temperatures, and has less odor or toxicity compared to oil-based solvents, so it is better because it does not deteriorate the working environment.

The water-soluble solvent (B) may be contained in an amount of 2% to 10% by weight based on the total weight of the metal nanoparticles (A) and the metal particles (X) protected by the dispersion stabilizer, and more preferably 3% to 6% by weight in terms of improving screen printing characteristics.

In the present disclosure, metal nanoparticles (A) having an average particle diameter in a range of 5 to 50 nm and metal particles (X) having an average particle diameter in a range of 100 to 700 nm are used together. Examples of such metal nanoparticles (A) and metal particles (X) include metal particles such as gold, silver, copper, and platinum. In the case of metal nanoparticles (A), conductive ink containing metal nanoparticles such as gold, silver, copper, and platinum can be used as a conductive material ink used in printed electronics, and silver nanoparticles and their ink have been developed in advance for economic feasibility and ease of handling. In addition, in the case of metal particles (X), silver particles are preferred among metal particles such as gold, silver, copper, platinum, etc., considering that there is no fear of clogging the screen printing mesh, fine patterns can be formed, and circuit wiring with low resistance after firing and good surface smoothness can be formed.

The conductive aqueous ink for screen printing of the present disclosure may be prepared by pre-mixing a metal nanoparticle (A) aqueous solution protected by a dispersion stabilizer, which is composed of a mixture of a polymer including polyalkylene imine segment having a side chain and a polyoxyalkylene segment, and a low molecular weight aminates, with a water-soluble solvent (B), as a need for example, and then stirring and dispersing with a certain shear force, or may be prepared by pre-mixing a metal nanoparticle (A) aqueous solution protected by a dispersion stabilizer which is composed of a mixture of a polymer including polyalkylene imine segment having a side chain and a polyoxyalkylene segment, and a low molecular weight aminates, with metal particles (X) and a water-soluble solvent (B), and then stirring and dispersing with a certain shear force.

In the method for preparing metal nanoparticles (A), which is an important component of the conductive aqueous ink for screen printing of the present disclosure, the metal nanoparticles (A) may be prepared by adding and reducing a small amount of metal ions into a solvent of a polymer, adding the remaining amount of metal ions again after a predetermined time and reducing to obtain metal nanoparticles, adding an appropriate poor solvent, precipitating, and separating the metal nanoparticles, thereafter, adding a low molecular weight aminates (C) to a concentrated solution of the separated metal nanoparticles. As a raw material for a metal ion, a metal salt or a metal ion solution can be mentioned. As a raw material for the metal ion, any water-soluble metal compound may be used, and salts of a metal cation and an acid group anion or a metal containing an acid group anion can be used. In addition, metal ions having metal types such as transition metals can be used, but among these metal ions, metal ions of silver, gold, and platinum are good because they are spontaneously reduced at room temperature or heated and converted into nonionic metal nanoparticles. Moreover, when using the obtained colloidal metal solution as an electrically-conductive material, it is preferable to use silver ions from the viewpoint of conductive expression ability or oxidation prevention of the coating film obtained by printing or painting.

The conductive aqueous ink for screen printing of this disclosure may contain various commonly used additives that improve printing properties or film properties, such as binder resins, antifoaming agents, surfactants, and rheology modulators, as needed, within a range that does not adversely affect the dispersion stability of the conductive aqueous ink or the performance of the printing film after firing.

By using the conductive aqueous ink composition for screen printing of the present disclosure obtained through the process described above, for example, circuit wiring patterns can be formed by printing and firing circuit wiring at a low temperature below 150° C. on a various thermoplastic substrates with low heat resistance such as PET, PEN, and polycarbonate, or with easy thinning or flexibility.

Accordingly, in another aspect, the present disclosure relates to a conductive pattern prepared by screen printing and firing on a substrate using the above-described conductive aqueous ink composition for screen printing. According to the present disclosure, since molding is simple and applied to inexpensive materials, weight reduction or miniaturization of the device is possible, firing is possible at a lower temperature than in the related art, and fine pattern printing with excellent flatness is possible. That is, the conductive pattern of the present disclosure is a fine conductive pattern, and for example, the conductive pattern having a line width and a line spacing of several tens of micrometers to several hundred micrometers, specifically about 15 to 100 μm, and more preferably about 15 to 50 μm may favorably be formed.

Accordingly, in another aspect, the present disclosure relates to a conductive device including a conductive pattern formed by using the aforementioned conductive aqueous ink composition for screen printing. In other words, by printing circuit wiring on a thermoplastic substrate with low heat resistance and easy thinning or flexibility using the conductive aqueous ink composition for screen printing of the present disclosure, conductive devices such as lightweight and miniaturized electrical and electronic components may be provided.

### EXAMPLE

Hereinafter, the present disclosure will be described in more detail by way of Examples, but the present disclosure is not limited to these Examples.

The analytical instruments and measurement methods used in the following examples are as follows.

1H-NMR: Nippon Electronics Co., Ltd., JNM ECP-400, 400 Hz

GPC measurement: Waters Corporation product, ACQUITY APC

Core System

TEM measurement: Hitachi Co., Ltd. product, H-7500

SEM measurement: Nippon Electronics Co., Ltd., JSM-6490LV

Volume resistivity measurement: Kikusui Co., Ltd. product, PMX35-3A, and Azirant Technology Co., Ltd. product, U1252A

Solid Content Measurement Method

The content of non-volatile substances, including metal nanoparticles contained in the silver nanoparticle centrifugal agglomeration paste, is measured. About 0.5 g of agglomeration paste from the silver nanoparticle centrifugal agglomeration paste prepared in the following example is dropped on an aluminum dish, pre-dried at 60° C., dried at 180° C. for 30 minutes using a hot air dryer to remove a residual solvent, and then the difference in weight of the sample before drying was calculated.

Solid content (%)=(weight of the sample after drying/weight of the sample before drying)×100

Method for Measuring Volume Resistance of Screen Printed Film

As in the following example, volume resistance was measured using a printed film sample that was screen-printed and fired with a conductive ink composition on a glass substrate. The thickness of the obtained screen-printed film sample was measured using SEM (manufactured by Nippon Electronics Co., Ltd., JSM-6490LV), and the surface resistivity (Ω/□) was measured using a low resistance resistor (manufactured by Azirant Technology, Inc., U1252A) and a constant current/constant voltage device (manufactured by Kikusui Co., Ltd. product, PMX35-3A).

Volume resistivity (Ωcm)=Surface resistivity (Ω/□)×Thickness (cm)

### Preparation Example 1 Synthesis of Protective Polymer

All of the following reactions were performed under a nitrogen atmosphere. 60.0 g of monomethoxy polyethylene glycol (Mn=2,000) and 420.0 ml of toluene were measured and introduced into a reactor, and after confirming the reaction solution was dissolved by heating to an internal temperature at 60° C. under a stirring speed of 200 rpm, and the internal temperature of the reaction solution is lowered to 18° C. or less. Thereafter, 20.0 ml of a toluene suspension solution of pulverized potassium hydroxide 4.0 was added to the reactor, and it was confirmed that the temperature of the reaction solution was maintained between 18° C. and 25° C. Then, 17.2 g of p-toluenesulfonyl chloride was added to the reaction vessel, and a little later, 60.0 ml of the toluene suspension solution of pulverized potassium hydroxide 12.0 was slowly added, and each time the toluene suspension was added to the reaction vessel, and it was confirmed that the temperature of the reaction solution was maintained between 18° C. and 25° C. Then, 2.0 g of p-toluenesulfonyl chloride was added to the reaction vessel, and then 40.0 ml of a toluene suspension solution of pulverized potassium hydroxide 8.0 was added. Similarly, it was confirmed that the temperature of the reaction solution was maintained at between 18° C. and 25° C., and then the reaction solution was further stirred for 30 minutes to be prepared.

In order to filter the reaction solution, filter paper (5 μm) and silica gel or anhydrous magnesium sulfate were placed on a Buchner funnel to prepare to filter, a vacuum pump was connected and then reduced pressure filtration was performed. Filtration under reduced pressure was repeated about 3 times until the filtered reaction mixture became a clear solution.

For the filtered reaction mixture, the solvent was distilled using a rotary evaporator. At this time, the cooling water was maintained at about 5° C., and the temperature of the rotary evaporator bath was maintained at 40° C. so that 50.4 g of tosylated polyethylene glycol monomethyl ether (yield 78%) was prepared.

1H-NMR (400 MHz) measurement results for the prepared product are as follows.

1H-NMR (D 20) measurement result:

δ(ppm)=7.8 (d, 2H), 7.2 (d, 2H), 4.2 (t, 2H), 3.7 to 3.8 (m, PEG methylene), 3.5 (s, 3H)

Subsequently, a target polymer is prepared by grafting polyethylene glycol to branched polyethyleneimine. All of the following reactions were performed under a nitrogen atmosphere. 380 g of dimethylacetamide was put into the reactor, heated slowly under a stirring speed of 200 rpm, 73.0 g of branched polyethyleneimine (Mn=10,000) was added, and then dissolved, and 48.0 g of tosylated polyethylene glycol monomethyl ether prepared above was added. After dissolution, 100.0 g of dimethylacetamide was added thereto. The temperature of the reaction solution was maintained by rising to 120° C., and the stirring reaction was maintained for about 6 hours.

After filtering the reaction solution, a solvent such as dimethylacetamide was distilled off using a reduced-pressure solvent removal device.

Then, about 320.0 g of distilled water was added to the reaction vessel to dissolve the reactant product well, and then the aqueous product solution was filtered using a Roca apparatus. At this time, 437.0 g of the prepared polymer product was prepared and stored in a 25% aqueous solution state.

1H-NMR (400 MHz) measurement results for the prepared product are as follows.

1H-NMR (D 20) measurement result:

δ (ppm)=3.5 to 3.6 (m, PEG methylene), 3.2 (s, 3H), 2.3 to 2.7 (m, bPEI ethylene)

GPC measurement result:

Rt=23,586, Mw=16,480

### Preparation Example 2 Synthesis of Silver Nanoparticle Centrifugation Agglomerated Paste

All of the following reactions were performed under a nitrogen atmosphere. 284 g of distilled water was put into the reactor, the stirring speed was operated at 100 rpm, 23.04 g of the polymer aqueous solution prepared in Preparation Example 1 was added, 181.2 g of dimethylethanolamine was added, and the reaction solution was heated to reach a temperature of 40° C. After confirming that, the stirring speed was adjusted to 200 rpm. Thereafter, 192 g of distilled water was added to 115.2 g of silver nitrate, and the previously stirred and dissolved aqueous silver nitrate solution began to be dropped over 30 minutes. The amount of the aqueous silver nitrate solution was dropped for 3 minutes, then the dropping was stopped for 3 minutes, stirred sufficiently to react, and the remaining aqueous nitrate was dropped for 24 minutes. After completing the dropwise addition of the aqueous silver nitrate solution, the reaction solution was heated, and the stirring reaction was maintained for about 3 hours from the point when the temperature reached 50° C.

In order to purify and separate the silver nanoparticles synthesized in the reaction solution, 800 g of the above synthesis mixture was added to 3,200 g of acetone, stirred for about 5 minutes, and left for a certain time to precipitate and separate the silver nanoparticles. After confirming the separation layer, the transparent supernatant solution was separated and removed, and then 4.7 g of the aqueous aminates solution prepared in advance was added to the separated silver nanoparticle solution and stirred.

For the preparation of the amine salt, 10.0 g of distilled water was added to 73.1 g of diethylamine (bp. 56° C.) using an ice bath, and 101.3 g of an aqueous hydrochloric acid solution (36%) was slowly added and mixed while stirring to obtain an aqueous aminates mixed solution with a molar ratio of 1:1. In addition, the silver nanoparticle solution to which the aqueous aminates solution was added was centrifuged at 2500 rpm for 10 minutes using a centrifuge to prepare 107.2 g of silver nanoparticle centrifugation agglomeration paste containing 82.0% silver solids.

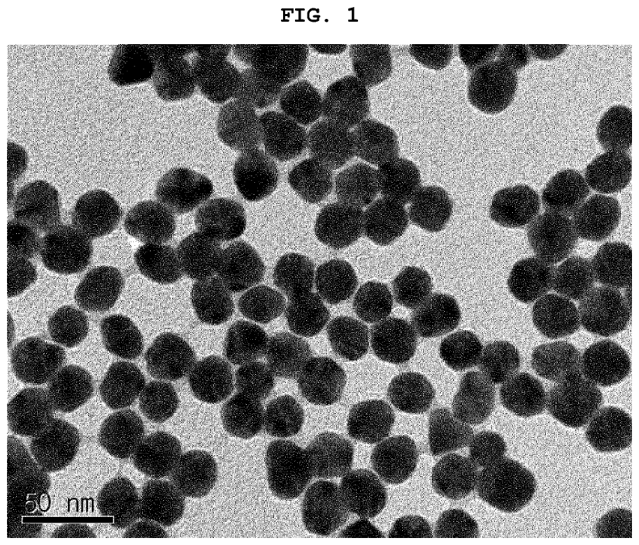

FIG. 1 shows the TEM measurement results of silver nanoparticles, and it can be confirmed that the silver nanoparticles have an average particle diameter of 23 nm and are monodisperse good crystalline particles.

### Example 1

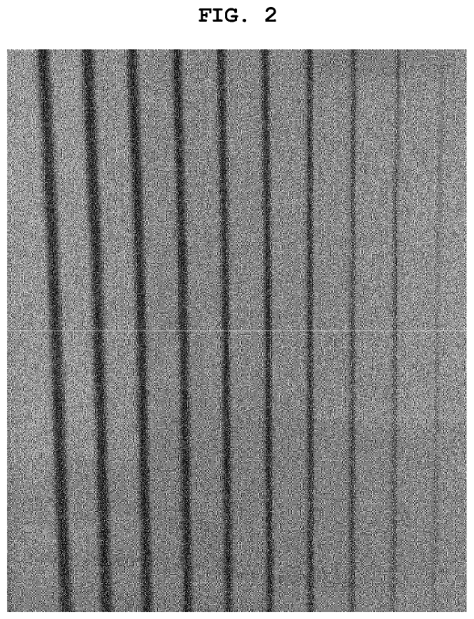

51.2 g of centrifugal agglomeration paste of metal nanoparticles (82% of non-volatile content) protected with a dispersion stabilizer which is composed of a mixture of a polymer including a branched polyalkylene imine segment and a polyoxyalkylene segment and a low molecular weight aminates obtained in Preparation Example 2, 4.2 g of glycerin, and 4.5 g of distilled water were added into a reactor and pre-mixed while stirring well, then kneaded and dispersed using a high-speed disperser, and additionally dispersed a small amount of a thickening agent if necessary, to prepare a conductive aqueous ink for screen printing. This conductive aqueous ink was screen-printed using a 300-mesh screen plate on a glass substrate and a PET substrate, and lines with various line widths were screen-printed to evaluate the printing properties by visual observation. The results are shown in FIG. 2. Referring to FIG. 2, it can be confirmed that the PET substrate has good printing properties because PET substrate can be printed to have various line widths, such as being coated with an ultra-fine line width by a screen printing method.

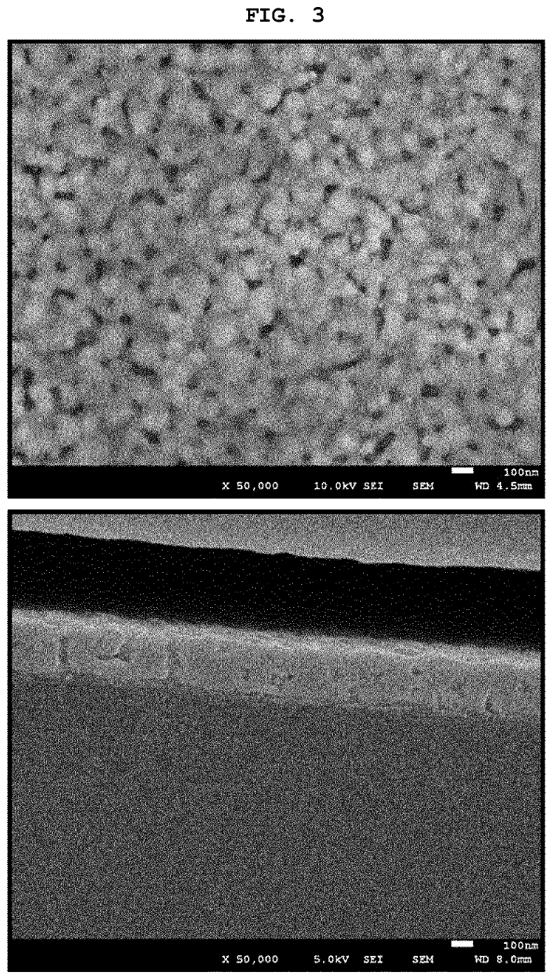

Subsequently, after printing on a glass substrate and firing at 120° C. for 30 minutes using a thermal oven, the continuous film state of the screen printing film after firing was confirmed by SEM measurement. The results are shown in FIG. 3. Referring to FIG. 3, it can be confirmed that the film is stably formed continuously, even firing at a low temperature after screen printing.

Further, the conductivity of the printed film was evaluated by the method for measuring the volume resistance of the screen-printed film.

### Example 2

A conductive aqueous ink for screen printing was prepared in the same manner as in Example 1, except that 25.6 g of centrifugation agglomerated paste (82% non-volatile content), 63.0 g of metal particles, which is a monodisperse silver powder manufactured by Yunjung Material Co., Ltd. (SP-004SM, dry powder of granular silver particles with an average particle diameter of 0.4 μm), 10.5 g of glycerin, and 9.6 g of distilled water were used instead of 51.2 g of centrifugation agglomerated paste (82% non-volatile content), 4.2 g of glycerin, and 4.5 g distilled water, and the printing characteristics and the conductivity of the printing film were evaluated by screen printing and firing.

### Example 3

A conductive aqueous ink for screen printing was prepared in the same manner as in Example 1, except that 25.6 g of centrifugation agglomerated paste (82% non-volatile content), 63.0 g of metal particles, which is a monodisperse silver powder manufactured by Yunjung Material Co., Ltd. (SP-004SM, dry powder of granular silver particles with an average particle diameter of 0.4 μm), 10.5 g of triethylene glycol, and 9.6 g of distilled water were used instead of 51.2 g of centrifugation agglomerated paste (82% non-volatile content), 4.2 g of glycerin, and 4.5 g distilled water, and the printing characteristics and the conductivity of the printing film were evaluated by screen printing and firing.

### Comparative Example 1

A conductive aqueous ink for screen printing was prepared in the same manner as in Example 1, except that 51.2 g of centrifugation agglomerated paste (82% non-volatile content) and 8.7 g of distilled water were used instead of 51.2 g of centrifugation agglomerated paste (82% non-volatile content), 4.2 g of glycerin, and 4.5 g distilled water, and the printing characteristics and the conductivity of the printing film were evaluated by screen printing and firing.

### Comparative Example 2

A conductive aqueous ink for screen printing was prepared in the same manner as in Example 1, except that 25.6 g of centrifugation agglomerated paste (82% non-volatile content), 63.0 g of metal particles, which is a monodisperse silver powder manufactured by Yunjung Material Co., Ltd. (SP-004SM, dry powder of granular silver particles with an average particle diameter of 0.4 μm), and 20.1 g of distilled water was used instead of 51.2 g of centrifugation agglomerated paste (82% non-volatile content), 4.2 g of glycerin, and 4.5 g distilled water, and the printing characteristics and the conductivity of the printing film were evaluated by screen printing and firing.

The evaluation results of Examples 1 to 3 and Comparative Examples 1 to 2 are summarized in Table 1 below.

| | | | | Compar- | Compar- |
|---|---|---|---|---|---|
| | | | | ative | ative |
| | Example 1 | Example 2 | Example 2 | Example 1 | Example 2 |
| Nano | 51.2 | 25.6 | 25.6 | 51.2 | 25.6 |
| particles¹⁾ | | | | | |
| Metal | — | 63.0 | 63.0 | — | 63.0 |
| particles²⁾ | | | | | |
| Distilled | 4.5 | 9.6 | 9.6 | 8.7 | 20.1 |
| water | | | | | |
| Glycerin | 4.2 | 10.5 | — | — | — |
| TEG³⁾ | — | — | 10.5 | — | — |
| Printability⁴⁾ | ◯ | ◯ | ◯ | X | X |
| Volume | 4.7 | 5.3 | 8.5 | 19 | 87 |
| resistivity | | | | | |
| (μΩcm) | | | | | |

¹⁾Centrifugation agglomerated paste of metal nanoparticles protected with a dispersion stabilizer which is composed of a mixture of a polymer including a branched polyalkylene imine segment and a polyoxyalkylene segment obtained in Preparation Example 2 and a low molecular weight aminates (82% non-volatile content)
²⁾Silver powder manufactured by Yunjung Material Co., Ltd. (silver flake dry powder with an average particle diameter of 40 nm)
³⁾Triethylene glycol
⁴⁾Printability: After screen printing a straight line with various line widths using a 300-mesh screen plate on a glass substrate and a PET substrate, if the state of the film is good, even if the appearance of bubbles and condensation of the film is observed during the printed film, it was judged as ◯, if the state of the film is bad, it was judged as X.

Referring to Table 1 above, when comparing Example 1, including silver nanoparticles protected by a dispersion stabilizer and a water-soluble solvent, and Comparative Example 1, including only distilled water instead of a water-soluble solvent, comparison in terms of printability in Comparative Example 1, it was found that the state of the coating film was poor, and the volume resistivity was also high as 19, indicating that the conductivity was lowered. On the other hand, in the case of Example 1, including a water-soluble solvent, the printability was good, and the volume resistance was as low as 4.7, indicating good conductivity.

In addition, when comparing Examples 2 and 3, which further includes silver particles in addition to the silver nanoparticles protected by the dispersion stabilizer and a water-soluble solvent, and Comparative Example 2, which includes only distilled water instead of the water-soluble solvent, Comparative Example 2 was found to have poor printability and a very high volume resistance of 87, indicating that the conductivity was significantly lowered. This is a very high value compared to Comparative Example 1, which means that it is difficult for the metal nanoparticles protected by the dispersion stabilizer to fill the space between the metal particles because the dispersibility is lowered due to the addition of the metal particles. On the other hand, in the case of Examples 2 and 3, even when metal particles were added, the volume resistance was 5.3 and 8.5, and it can be confirmed that the conductivity was significantly improved and good printability was exhibited compared to Comparative Example 2. This is because Examples 2 and 3 further include a water-soluble solvent, and thus have good mixing with the aqueous metal nanoparticle solution protected by the dispersion stabilizer and do not cause phase separation, thereby increasing dispersion stability and filling the space between the metal nanoparticles. Accordingly, it is possible to exhibit excellent conductivity by lowering the volume resistance by connecting the metal particles as well as good printability.

As described above, from the results of Examples 1 to 3 and Comparative Examples 1 and 2, the conductive aqueous ink composition for screen printing of the present disclosure has good screen printing properties and can form a thin metal film at low-temperature firing. As a result of measuring the volume resistance, it was confirmed that the volume resistivity was 4.7 to 8.5 μΩcm in firing at 120° C., indicating good conductivity.

### INDUSTRIAL APPLICABILITY

Accordingly, the conductive aqueous ink composition for screen printing, according to the present disclosure, can be performed firing at a low temperature to form circuit wirings exhibiting good conductivity. In addition, the ink composition of the present disclosure does not dissolve or swell general-purpose plastic substrates, unlike conventional oil-based inks, and has no odor or toxicity, so there is no deterioration of the working environment, and there is no risk of fire and explosion, thereby expecting high industrial availability.

1. A conductive aqueous ink composition for screen printing, the composition comprising:
(A) metal nanoparticles protected by a dispersion stabilizer and having a particle size in a range of 5 to 50 nm; and
(B) a water-soluble solvent (B),
wherein the dispersion stabilizer comprises:
a protective polymer comprising a branched polyalkylene imine segment and a polyoxyalkylene segment; and
an aminates comprising an amine and an inorganic acid.

2. The composition of claim 1, wherein the ink further comprises (X) metal particles having a particle size in a range of 100 to 700 nm.

3. The composition of claim 1, wherein a solid content of the metal nanoparticles or a solid content of the metal nanoparticles and metal particles is 60% to 90% by weight.

4. The composition of claim 1, wherein the water-soluble solvent is at least one selected from an alkylene glycol-based solvent and glycerin.

5. The composition of claim 1, wherein the metal nanoparticles or metal particles are silver nanoparticles or silver particles.

6. A conductive pattern prepared by screen printing the conductive aqueous ink composition of claim 1 on a substrate and firing the conductive aqueous ink.

7. A conductive device comprising the conductive pattern of claim 6.

8. The composition of claim 2, wherein a solid content of the metal nanoparticles or a solid content of the metal nanoparticles and metal particles is 60% to 90% by weight.

9. The composition of claim 2, wherein the water-soluble solvent is at least one selected from an alkylene glycol-based solvent and glycerin.

10. The composition of claim 2, wherein the metal nanoparticles or metal particles are silver nanoparticles or silver particles.

11. A conductive pattern prepared by screen printing the conductive aqueous ink composition of claim 2 on a substrate and firing the conductive aqueous ink.

12. A conductive device comprising the conductive pattern of claim 11.
